(19) United States
(12) Patent Application Publication
(10) Pub. No.: US 2004/0174254 A1
(43) Pub. Date: Sep. 9, 2004

(54) Industrial timer unit and control unit

(76) Inventors: Angelito D. Siwa, Bridgeview, IL (US); Angelito D. Natividad, Beverly Hills, FL (US)

Correspondence Address: Jonathan Feuchtwang, Suite 1200, 150 N. Wacker Drive, Chicago, IL, 60606, US

(21) Appl. No.: 10/790,297

(22) Filed: Mar. 1, 2004

Related U.S. Application Data
(60) Provisional application No. 60/451,505, filed on Mar. 3, 2003.

(51) Int. Cl. H04L 1/00; H04J 1/16

(52) U.S. Cl. 340/438

(57) ABSTRACT

An industrial timer unit for monitoring a service interval of an internal combustion engine including a timer measuring an accumulated time the engine has operated; a timer control module receiving the accumulated time from the timer, and selectively zeroing the accumulated time; an oil service indicator for alerting in response to a signal from the timer control module.

### PRIORITY CLAIM

Applicants hereby claim priority based upon U.S. Provisional Patent Application Serial No. 60/451,505, filed Mar. 3, 2003, entitled “INDUSTRIAL TIMER UNIT AND CONTROL UNIT,” the entirety of which is hereby incorporated by reference.

### FIELD OF THE INVENTION

The present invention relates to a device for monitoring the engine run time between oil changes.

### BACKGROUND OF THE INVENTION

The deleterious affects of viscosity breakdown of engine lubricants are well understood. Sensors for directly measuring the viscosity of engine oil are relatively expensive. For this reason most cars are not equipped such sensors. In the absence of a direct measurement of the lubricant viscosity, automobile manufacturers specify service intervals in terms of the number of miles and/or an elapsed time since the last service. Typically, consumers are told to change the engine lubricant every 3000 miles or 3 months whichever occurs first.

The advantage of such a heuristic is its relative ease of measurement and implementation. Unfortunately, the conventional one-size-fits-all heuristic does not account for the driving characteristics of different users. Users such as taxis frequently allow the engine to idle for prolonged periods which dramatically hastens the occurrence of viscosity breakdown. Other users drive long distances at highway speeds, and thus do not encounter viscosity breakdown at 3000 miles.

Mileage alone is not a good indicator of viscosity breakdown. The conventional 3000 mile service interval used by many vehicle owners results in some drivers changing their lubricant too frequently, which wastes money and pollutes the environment. Correspondingly, the conventional 3000 mile service interval results in some drivers not changing their lubricant frequently enough, which reduces the life of the engine.

What is needed is an inexpensive device which provides a better measure of viscosity breakdown.

### SUMMARY OF THE INVENTION

Disclosed is an industrial timer unit for monitoring a service interval of an internal combustion engine. The industrial timer unit (ITU) includes a timer measuring an accumulated time the engine has operated; a timer control module receiving the accumulated time from said timer, and selectively zeroing said accumulated time; and an oil service indicator for alerting in response to a signal from said timer control module.

According to one aspect of the invention the timer control unit stores a predefined service interval.

According to one aspect of the invention the predefined service interval is user selectable.

According to one aspect of the invention the zeroing of the timer control unit is user selectable.

According to one aspect of the invention the indicator includes at least one of a visual and an audible alert.

According to one aspect of the invention the ITU includes a memory for storing the accumulated engine run time. Moreover, the ITU may include a battery for the memory. Still further the ITU may be equipped with a battery service indicator operatively connected to the battery, the battery service indicator alerting a user when the battery requires servicing.

According to one aspect of the invention the oil service indicator provides a visual indication of the percentage of time remaining in the service interval. The percentage may be calculated as a quotient of the accumulated time and the service interval.

The ITU of the present invention is used to measure the run-time of an internal combustion engine. The ITU comprises a main body including: a timer measuring an accumulated time the engine has operated; and a timer control module receiving the accumulated time from said timer, and selectively zeroing said accumulated time; and a remote body including an oil service indicator for alerting in response to a signal from said timer control module.

According to one aspect of the invention the remote body is adapted to be positioned within a passenger compartment of an automobile within the visual sightline of driver.

According to one aspect of the invention the main body is adapted to be mounted within the engine compartment of an automobile.

According to one aspect of the invention the main body is adapted to be positioned within a passenger compartment of an automobile outside of the visual sightline of driver.

According to one aspect of the invention the main body includes a transmitter, said remote body includes a receiver, and said control unit transmits wireless signals to said remote body.

Also disclosed is a system for monitoring a service interval for an internal combustion engine, comprising: an industrial timer unit and a base unit communicating with said industrial timer unit. The industrial timer unit is adapted to be mounted to a vehicle having an internal combustion engine and includes a timer measuring an accumulated time the engine has operated; a timer control module receiving the accumulated time from said timer, and selectively zeroing the accumulated time; and an oil service indicator for alerting in response to a signal from the timer control module. The base unit receives the accumulated time from the industrial timer, and storing the accumulated time in a database.

In the preceding system, the industrial timer unit may include an identifier uniquely identifying the industrial timer unit. The identifier (which may be burned into a ROM) may be included in transmissions between the base unit and the industrial timer unit.

In a system according to present invention the industrial timer unit may include a transceiver and the base unit comprises a transceiver, and the base unit communicates with the industrial timer unit using wireless transmissions.

In a system according to present invention the base unit may be used to zero the accumulated time in a given timer control module.

In a system according to present invention the base unit may be used to monitor plurality of industrial timer units.

### BRIEF DESCRIPTION OF THE DRAWINGS

The invention may be understood by reference to the following description taken in conjunction with the accompanying drawings, in which like reference numerals identify like elements, and in which:

FIG. 1A is a table showing the engine run time, actual mileage, and viscosity break down for a particular user;

FIG. 1B is a graph showing the relationship between engine run time and mileage driven for a particular user;

FIG. 1C is a graph showing the relationship between engine run time and viscosity break down for a particular user;

FIGS. 2A and 2B are functional blocks diagram of an industrial timer unit according to the present invention;

FIG. 3A is a functional block diagram of a base unit for communicating with the industrial timer unit of FIGS. 2A and 2B; and

FIG. 3B is a functional block diagram of system including a base unit according to FIG. 3 and at least one industrial timer unit according to FIGS. 2A or 2B.

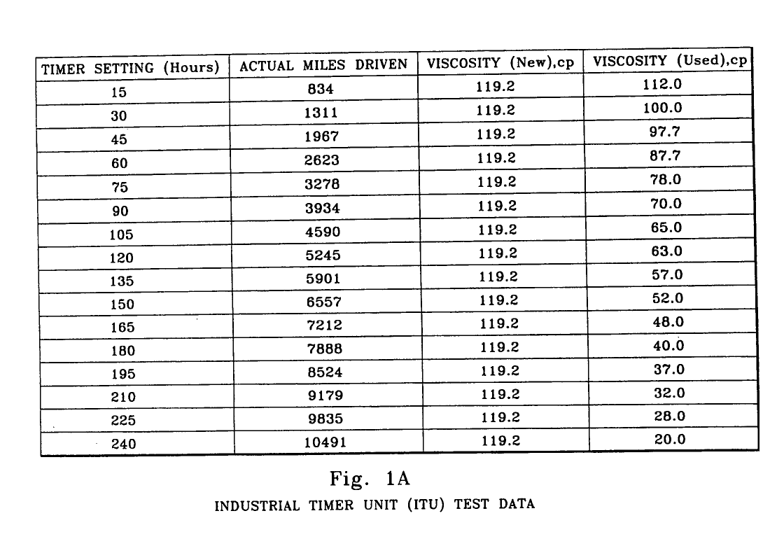

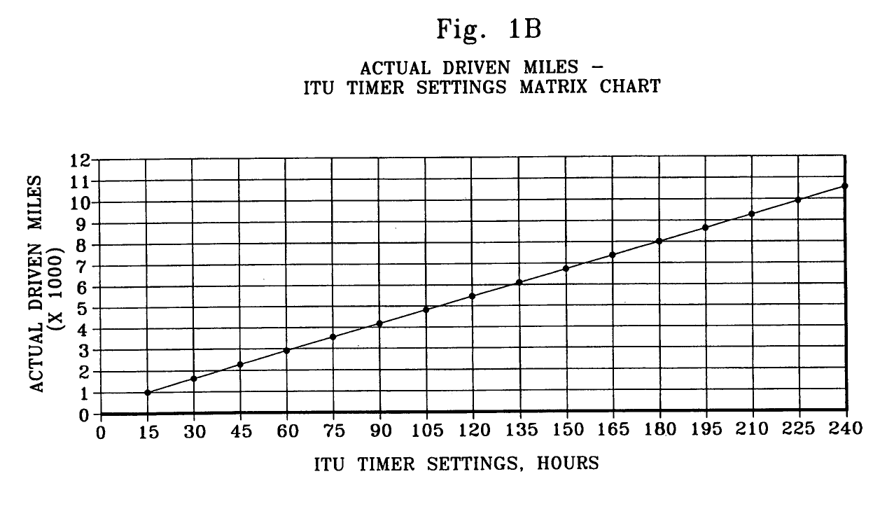

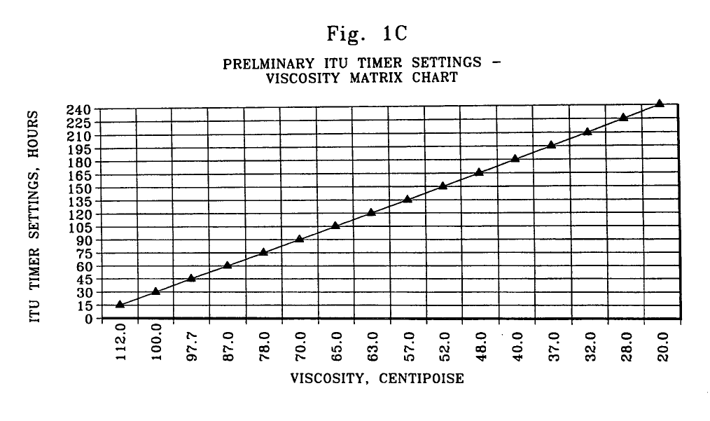

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

The present invention relates to a timer and control system for recommending engine service based on the actual running time of an engine. The present invention does not directly measure viscosity breakdown, but instead measures the engine run time which has a high degree of correlation with viscosity breakdown.

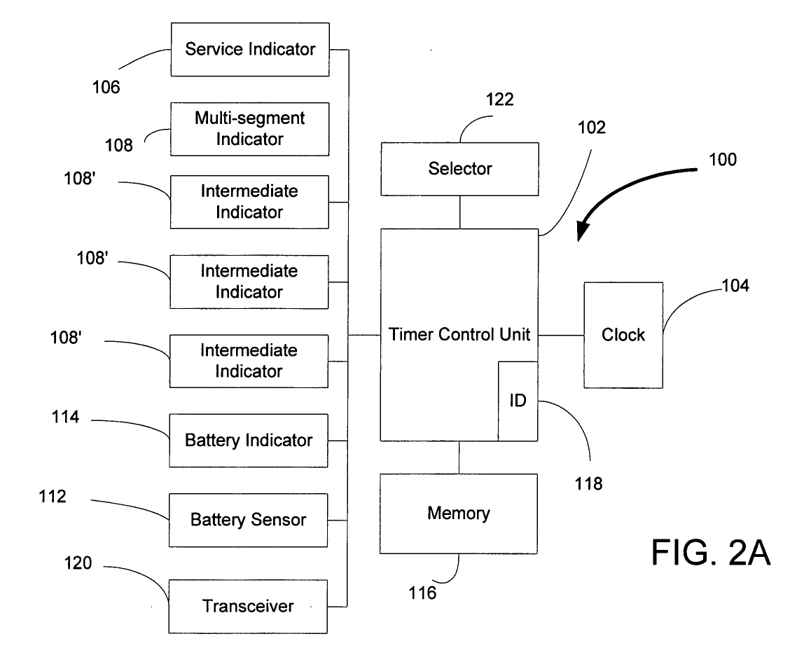

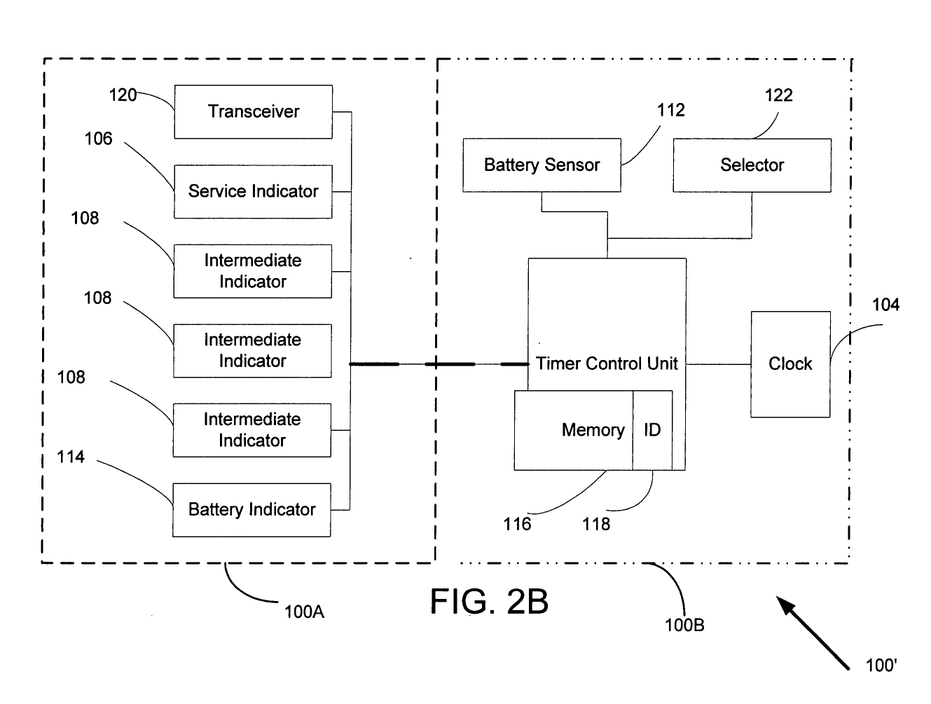

FIG. 2A is a functional block diagram of an industrial timer unit 100 according to the present invention. As shown the industrial timer unit 100 includes a timer control module 102 used to specify the service interval, a clock or timer 104 which counts up or down from the service interval specified by the timer control device 102, and an indicator 106 for alerting the user of the need to service the engine.

The timer control module 102 is provided with a memory 116 for storing the accumulated engine run-time since the last time the unit was reset. The memory 116 may be any of a variety of commercially available memory devices such as random access memory or an erasable read only memory or the like capable of storing the accumulated engine run time.

In the most basic embodiment, the clock or timer 104 triggers the indicator 106 when the service interval has been reached. In this most basic embodiment the indicator 106 can be a visual indicator such as a light emitting diode and/or a visual indicator such as a buzzer or the like.

In the embodiment depicted in FIGS. 2A the maintenance interval set point is manually selected using a selector 122 (FIG. 2A). The invention is not limited to the use of any particular selector; however, a series of dip switches or a rotary switch are contemplated and fall within the scope of the invention. Still further, the set point can be stored in a programmable memory or burned into a ROM.

According to a slightly more enhanced embodiment of the invention, the industrial timer unit 100 includes a multi-segment indicator 108 or a series of intermediate indicators 108′ (FIG. 2A) which alert the user as the run-time nears the service interval. The intermediate indicators 108 can be a visual indicator such as a light emitting diode or the like. In this embodiment, the timer control unit 100 triggers different segments of the multi-segment indicator 108 or different ones of the intermediate indicators 108′ a pre-determined amount of time before the engine requires servicing.

Alternatively, the indicators 108, 108′ may be configured to provide more detailed information, such as the percentage of run time remaining before the engine requires servicing. For the sake of example, the industrial timer unit 100 may be provided with three indicators 108, 108′ with the first indicator signifying that 25% of the service interval has elapsed, the second indicator signifying that 50% of the service interval has elapsed, and the third indicator signifying that 75% of the service interval has elapsed.

Further still, the intermediate indicator 108 may be an analog meter.

Advantageously, the industrial timer 100 of the present invention may readily be added as an after-market option to an existing device such as an automobile or the like. The industrial timer 100 is much simpler to install than a car radio, and simply requires connection to a continuous power source and to the alternator or the like. The engine run time is correlated with the flow of current through the alternator since current flows through the alternator whenever the engine is running.

According to a preferred embodiment, the industrial timer 100 is mounted within the passenger compartment of the automobile such that the indicator 106 and intermediate indicator(s) 108 are within the visual range of the user.

The industrial timer unit 100 (FIG. 2A) may be broken into a main body portion 100A and a remote indicator panel 100B (the combination of 100A and 100b will be referenced as 100′). See FIG. 2B. The main body portion 100A may be mounted in a location outside the visual range of the user, e.g. below the dashboard or within the engine compartment. The remote indicator panel 100B would then be provided within the visual range of the user. Communication between the remote indicator panel 100B and the main body portion 100A may be accomplished using a direct physical connection, or may be a wireless communication. One of ordinary skill in the art will appreciate that there are a multitude of ways to accomplish a wireless connection between the remote indicator panel 100B and the main body portion 100A. For example, the main body portion 100A may be equipped with a transmitter or transceiver 120 and the remote indicator panel 100B may be equipped with a receiver or transceiver 120.

As noted above, the timer control unit 102 is provided with a memory 116 for storing the accumulate engine run time. A battery 110 may optionally be provided to ensure that the engine run time information is retained in the case of power interruption. Further, a battery sensor 112 may optionally be provided to monitor the condition of the battery 110 and trigger a warning indicator 114 such as a light emitting diode and or a buzzer in the event the battery 110 requires service.

Alternatively, the memory 116 may be a non-volatile memory which retains memory even in the absence of power, thereby eliminating the need for the battery 110, battery sensor 112, and warning indicator 114.

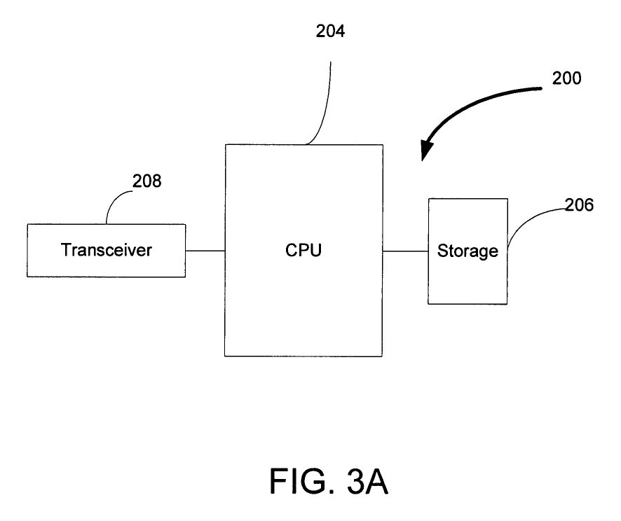

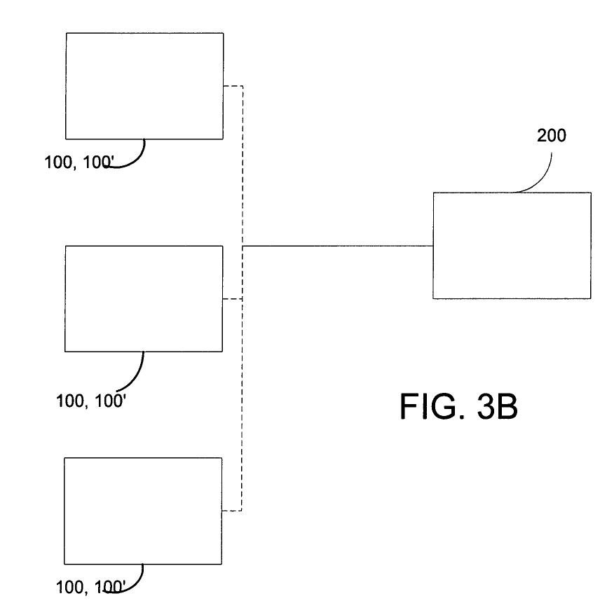

The industrial timer 100 of the present invention is ideally suited for monitoring fleet operations. A control module 200 (FIGS. 3A, 3B) may communicate with one or more industrial timers 100 for reading and controlling the industrial timer 100, 100′.

The control module 200 receives (retrieves) and stores engine run time information from the industrial timer unit 100. Data is transferred between the control module 200 and the industrial timer unit 100 using known means. Notably data may be transferred over a cable or via a wireless connection. An optional pair of transceivers 208 may be provided to facilitate wireless communication between the control module 200 and the ITU 100, 100′. See FIG. 3B.

The control module 200 (FIG. 3A) includes a central processing unit (CPU) 204 for communicating with the timer control unit 102, and data storage 206.

The industrial timer 100 (FIG. 2A) may include an identifier 118 which may reside in a read only memory (ROM), programmable read only memory (PROM) or the like for uniquely identifying the vehicle.

The control module 200 reads the engine run time and (optionally) the unit identifier 116 from the industrial timer 100, and stores the information in the memory 206. Moreover, the control module 200 may be used to adjust the maintenance interval set point stored in the industrial timer 100.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention.

We claim:

1. An industrial timer unit for monitoring a service interval of an internal combustion engine, comprising:
a timer measuring an accumulated time the engine has operated;
a timer control module receiving the accumulated time from said timer, and selectively zeroing said accumulated time;
an oil service indicator for alerting in response to a signal from said timer control module.

2. The industrial timer unit according to claim 1, wherein said timer control unit stores a predefined service interval.

3. The industrial timer unit according to claim 1, wherein said predefined service interval is user selectable.

4. The industrial timer unit according to claim 1, wherein said zeroing of the timer control unit is user selectable.

5. The industrial timer unit according to claim 1, wherein said indicator comprises at least one of a visual and an audible alert.

6. The industrial timer unit according to claim 1, further comprising a memory for storing said accumulated time.

7. The industrial timer unit according to claim 6, further comprising a battery for said memory.

8. The industrial timer unit according to claim 1, further comprising a battery service indicator operatively connected to said battery, said battery service indicator alerting a user when said battery requires servicing.

9. The industrial timer unit according to claim 2, wherein said oil service indicator provides a visual indication of the percentage of time remaining in said service interval.

10. The industrial timer unit according to claim 9, wherein said percentage is calculated as the quotient of the accumulated time and the service interval.

11. An industrial timer unit for an internal combustion engine, comprising:
a main body including:
a timer measuring an accumulated time the engine has operated; and
a timer control module receiving the accumulated time from said timer, and selectively zeroing said accumulated time; and
a remote body including an oil service indicator for alerting in response to a signal from said timer control module.

12. The industrial timer unit according to claim 11, wherein said remote body is adapted to be positioned within a passenger compartment of an automobile within the visual sightline of driver.

13. The industrial timer unit according to claim 11, wherein said main body is adapted to be mounted within the engine compartment of an automobile.

14. The industrial timer unit according to claim 11, wherein said main body is adapted to be positioned within a passenger compartment of an automobile outside of the visual sightline of driver.

15. The industrial timer unit according to claim 11, wherein said main body includes a transmitter, said remote body includes a receiver, and said control unit transmits wireless signals to said remote body.

16. A system for monitoring a service interval for an internal combustion engine, comprising:
an industrial timer unit mounted to a vehicle having an internal combustion engine, said industrial timer unit including:
a timer measuring an accumulated time the engine has operated;
a timer control module receiving the accumulated time from said timer, and selectively zeroing said accumulated time; and
an oil service indicator for alerting in response to a signal from said timer control module; and
a base unit communicating with said industrial timer unit, said base unit receiving said accumulated time from said industrial timer, and storing said accumulated time in a database.

17. The system according to claim 16, wherein said industrial timer unit comprises an identifier uniquely identifying said industrial timer unit, said identifier being included in transmissions between said base unit and said industrial timer unit.

18. The system according to claim 16, wherein said industrial timer unit comprises a transceiver and said base unit comprises a transceiver, and said base unit communicates with said industrial timer unit using wireless transmissions.

19. The system according to claim 16, wherein said timer control module zeroes said accumulated time in response to a signal from said base unit.

20. The system according to claim 17, wherein a plurality of industrial timer units communicate with said base unit.
